(19) United States
(12) Patent Application Publication
(10) Pub. No.: US 2009/0260501 A1
(43) Pub. Date: Oct. 22, 2009

(54) MULTI-MODE OPTICAL FIBER SENSOR

(76) Inventor: Raman KASHYAP, Baie d'Urfe (CA)

Correspondence Address: OGILVY RENAULT LLP, 1, Place Ville Marie, SUITE 2500, MONTREAL, QC, H3B 1R1, CA

(21) Appl. No.: 12/426,746

(22) Filed: Apr. 20, 2009

Related U.S. Application Data
(60) Provisional application No. 61/046,005, filed on Apr. 18, 2008.

(51) Int. Cl. G10D 3/10; G02B 6/00

(52) U.S. Cl. 84/297 S; 385/13

(57) ABSTRACT

There is described an optical fiber sensor for sensing one of vibration, temperature, and strain, comprising: a laser source; a first single mode optical fiber having a first end and a second end, the first end connected to the laser source for receiving and propagating light from the laser source; a multimode optical fiber having a first end and a second end, the first end connected to the second end of the first single mode optical fiber for receiving the light and thereby exciting a plurality of modes of the multimode optical fiber, the multimode optical fiber being stretched at an out of band frequency and operated at a point at which an output is a linear function of a displacement of the multimode fiber; and a sampling photo-detector module connected to the second end of the multimode optical fiber for spatially filtering an output of the multimode fiber to obtain a spatially filtered interference pattern, and for detecting a variation of the spatially filtered interference pattern when one of the vibration, temperature, and strain is applied to the multimode optical fiber.

### CROSS-REFERENCE TO RELATED APPLICATIONS

The present application claims priority under 35 USC§119(e) of Provisional Patent Application bearing Ser. No. 61/046,005, filed on Apr. 18, 2008, the contents of which are hereby incorporated by reference.

### TECHNICAL FIELD

The present invention relates to the field of optical fiber sensors, and more particularly, to the use of a multimode fiber to detect vibration, temperature, and strain.

### BACKGROUND OF THE INVENTION

Optical fiber sensors are devices in which the physical quantity to be measured is made to modulate the intensity, spectrum, phase, or polarization of light from a light-emitting diode or laser diode traveling through an optical fiber. The modulated light is detected by a photodiode.

An example of such a device includes the measurement of strain through the direct change in the refractive index of the guided mode using a variety of techniques, such as interferometry, RF modulation of light, and temperature. Another example is distributed sensing which has been implemented with Raman and Brillouin scattering. Vibration and acoustic sensing has been performed using holography and an array of Fiber Bragg Gratings (FBG) in the form of a hydrophone. Other schemes use the evanescent field from an optical fiber to sense temperature, local strain using FBGs and discrimination between strain and temperature in FBGs.

Since optical fibers have been shown to be very useful for these types of applications, there is a need to further develop in this area in order to address issues such as increased sensitivity of a sensor, simplicity of design, and others.

### SUMMARY OF THE INVENTION

In accordance with a first broad aspect, there is described an optical fiber sensor for sensing one of vibration, temperature, and strain, comprising: a laser source; a first single mode optical fiber having a first end and a second end, the first end connected to the laser source for receiving and propagating light from the laser source; a multimode optical fiber having a first end and a second end, the first end connected to the second end of the first single mode optical fiber for receiving the light and thereby exciting a plurality of modes of the multimode optical fiber, the multimode optical fiber being stretched at an out of band frequency and operated at a point at which an output is a linear function of a displacement of the multimode fiber; and a sampling photo-detector module connected to the second end of the multimode optical fiber for spatially filtering an output of the multimode fiber to obtain a spatially filtered interference pattern, and for detecting a variation of the spatially filtered interference pattern when one of the vibration, temperature, and strain is applied to the multimode optical fiber.

In accordance with a second broad aspect, there is provided a method for sensing one of vibration, temperature, and strain, the method comprising: stretching a multimode optical fiber at an out of band frequency such that it operate at a point at which an output is a linear function of a displacement of the multimode optical fiber; powering a laser source coupled to a first end of a first single mode optical fiber; propagating light through the first single mode optical fiber, a second end of the first single mode optical fiber being coupled to a first end of the multimode optical fiber; exciting a plurality of modes in the multimode optical fiber by coupling the light propagating through the first single mode optical fiber into the multimode optical fiber; spatially filtering an output of the multimode fiber to obtain an interference pattern; and detecting a variation of the interference pattern when one of the vibration, temperature, and strain is applied to the multimode optical fiber.

In accordance with a third broad aspect, there is provided a musical instrument comprising: a housing having a neck and a body; a plurality of tuning pegs at one end of the neck; a bridge on the body; and a multimode fiber having a plurality of segments stretched at an out of band frequency and operated at a point at which an output is a linear function of a displacement of the multimode fiber, each one of the segments extending from one of the tuning pegs to the bridge, the bridge holding the multimode fiber in place on the body, the multimode optical fiber being wrapped around each one of the tuning pegs, the tuning pegs adjustable for tensioning each of the segments of the multimode optical fiber.

In this specification, the term “optical fiber sensor” is intended to mean a device that can respond to any one of pressure, temperature, liquid level, position, flow, smoke, displacement, electric and magnetic fields, chemical composition, and numerous other conditions, while using an optical fiber as a detection mechanism.

Various applications of the optical fiber sensor described herein are musical instruments, seismic detection, dynamic vibration sensing, and monitoring of sensitive locations such as oil rigs, terrains, and mines, among others.

### BRIEF DESCRIPTION OF THE DRAWINGS

Further features and advantages of the present invention will become apparent from the following detailed description, taken in combination with the appended drawings, in which:

FIG. 1 is a schematic diagram of an embodiment of an optical fiber sensor for vibration, strain, or temperature;

FIG. 2 is a graph illustrating the optical path length difference and the interference signals for LP01-LP11 and LP01-LP02 modes, in accordance with one embodiment;

FIG. 3 illustrates an intensity distribution for LP01 and LP11, as well as an intensity distribution for the sum of the two modes;

FIG. 4 is a schematic of the sensor embodied by a musical instrument, namely a violin, in accordance with one embodiment;

FIG. 5 is a schematic of the sensor embodied by a guitar, in accordance with one embodiment;

FIG. 6 illustrates a replacement peg box used in an embodiment of the guitar of FIG. 5;

FIG. 7 is a graph illustrating a Fast Fourier Transform of a signal detected by a photo-detector, showing a single dominant resonance;

FIG. 8 is a graph illustrating a Fast Fourier Transform of a signal detected by a photo-detector, showing the vibrating fiber with rich harmonic content to about the 17^{th} harmonic;

FIG. 9 is a graph illustrating measured frequency versus the square root of the extension of the fiber; and

FIG. 10 is a graph illustrating the frequency of a detected signal versus 1/L.

It will be noted that throughout the appended drawings, like features are identified by like reference numerals.

### DETAILED DESCRIPTION

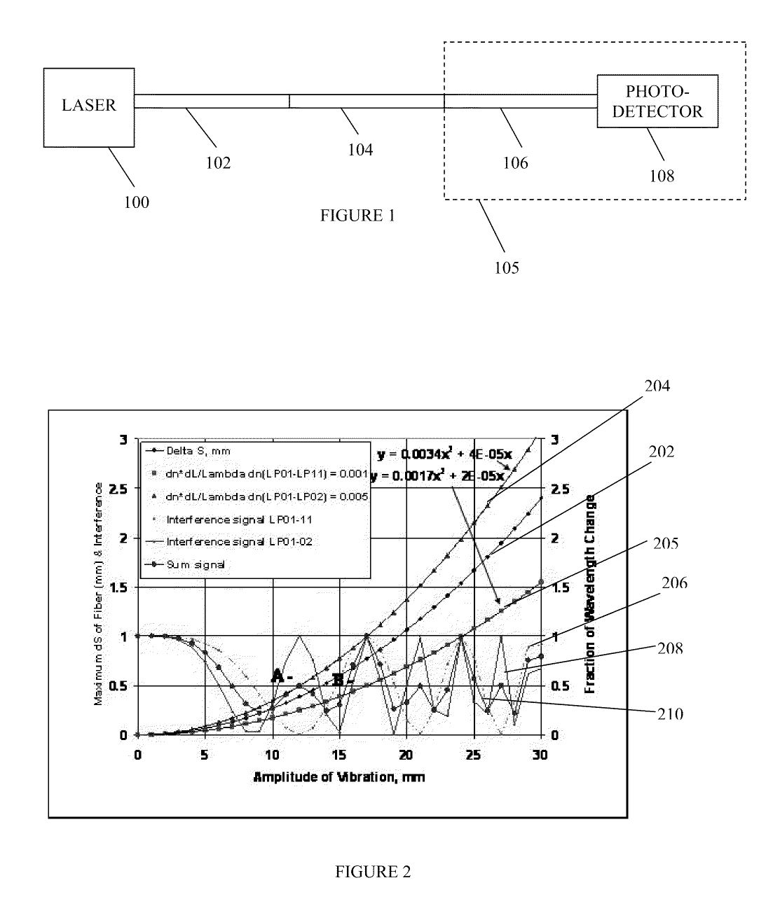

FIG. 1 illustrates an embodiment of an optical fiber sensor for sensing vibration, temperature, or strain. A laser source 100 is coupled to a first single mode optical fiber 102. The laser source 100 may be any of several devices that emit highly amplified and coherent radiation of one or more discrete frequencies. It may operate in the infrared, visible, or ultraviolet region. The single mode fiber 102 may be any optical fiber designed to carry only one ray of light. A core and cladding are present, without any limit to the diameter of either, except those relating to the single mode parameters. Special types of single-mode optical fibers which have been chemically or physically altered to give special properties, such as dispersion-shifted fiber and nonzero dispersion-shifted fiber, may also be used.

Coupled to the other end of the first single mode optical fiber 102 is a multimode optical fiber 104 of length L. The two fibers 102 and 104 may be coupled using any known fiber coupling techniques, such as fusion splicing, mechanical splicing, and other techniques known to those skilled in the art. At the output of the multimode optical fiber 104 is a sampling and detecting module 105, which is used for spatially filtering an output of the multimode fiber 104 to obtain a spatially filtered interference pattern, and for detecting a variation of the spatially filtered interference pattern when vibration, temperature, or strain is applied to the multimode optical fiber 104.

In one embodiment, the sampling and detecting module 105 comprises a second single mode optical fiber 106, also coupled by any known technique, which acts as a spatial filter to the output of the multimode optical fiber 104. Other types of spatial filters may be used instead of the second single mode optical fiber 106, such as a small photodiode, or any other optical device, which uses the principles of Fourier optics to alter the structure of a beam of coherent light or other electromagnetic radiation. The spatial filter, or second single mode optical fiber 106, is then coupled to a photo-detector 108. The photo-detector 108 detects a variation of the spatially filtered output when vibration, temperature, and strain is applied to the multimode optical fiber 104.

The multimode optical fiber 104 has the capability of carrying several modes. For example, if the multimode optical fiber 104 is excited with a single mode optical fiber, many modes may be excited, depending on the coupling coefficients of the modes. In a typical 50 micron diameter multimode optical fiber, there is a possibility of exciting several hundred modes. However, in reality, only a few modes are excited, those which couple easily to the modal shape of the single-mode exciting fiber. We have seen several of the lower order modes (LP₀₁, LP₁₁, LP₂₁, LP₀₂ and a few others) at the output of a multimode optical fiber, when a single mode fiber is spliced to the multimode optical fiber.

For the multimode optical fiber to function as a sensor, the interference at the single mode output fiber, of the several modes propagating in the fiber must be a function of the sensed parameter, e.g. temperature, strain, vibration etc. If a multimode optical fiber is strained and held under tension at two points separated by length, L, then it is free to vibrate. The problem here is to relate the change in the optical length of the fiber to the interference signal received at the photodiode. Modes that have electric field polarizations that are similar will readily interfere. Thus for the purposes of the present analysis, we assume that the fiber propagates the following there modes: LP01, LP11 and LP02 (the LP21 mode which has nearly the same propagation constant as the LP02, has field polarizations that do not contribute significantly to the interference signals, and are ignored, although a more rigorous analysis may include this and other modes easily. However, for the purposes of the present analysis, the main feature of the problem remains unchanged, and other modes are ignored).

The propagation constants of each mode LPₘₙ where the mn indicates the order of the mode (n), of the type (m), are designated as βₘₙ. Thus, LP₀₁ and LP₀₂ are of the same type, m, but are of different order (0 and 2), n. The polarizations of the two modes may be approximated as being linear (but with the freedom of two orthogonal polarization), and for the present analysis we will assume that they have the same polarization, say vertical. Similarly, for the LP₁₁ the polarization is assumed to be identical as the other two modes. If the propagation constants of the modes are β₀₁, β₁₁ and β₀₂, then the mismatch between the phase differences between any two modes is given by:

(Δβ₀₁₋₁₁)L=(β₀₁−β₁₁)L

(Δβ₀₁₋₀₂)L=(β₀₁−β₀₂)L (1)

(Δβ₁₁₋₀₂)L=(β₀₁−β₀₂)L

where, L is the length of the fiber. The interference signal at the photodiode is given by a cos²(θ) function where θ is the phase difference between the modes for each pair of modes. These are weighted by the amplitude and overlap between the different modes, so that the output of the photodiode is:

S=A cos²(Δβ₀₁₋₁₁L)+B cos²(Δβ₀₁₋₀₂L)+C cos²(Δβ₀₂L) (2)

where, A, B, C are the weighting factors depending on the intensity in each mode and the overlap between the interfering modes. If the fiber's optical length is changed by ΔL, for example as a result of strain, temperature or other disturbance σ, then Eq. (2) is altered to:

S(σ)=A cos²(Δβ₀₁₋₁₁[L+ΔL])+B cos²(Δβ₀₁₋₀₂[L+ΔL])+C cos²(Δβ₀₂[L+ΔL]) (3)

It can be shown that the length of an oscillating string,

$$S = [ \frac{{L}^{2} + 4 δ {x}^{2}}{4 δ x} ] {sin}^{- 1} ( \frac{4 L δ x}{{L}^{2} + 4 δ {x}^{2}} ) ,$$

where δx is the transverse displacement at the maximum, and L is the length of the string. Thus the length change, δS=S−L. Given this change in length, one can calculate the change in the optical path of three modes propagating in a multimode fiber, e.g. LP₀₁, LP₀₂, and LP₁₁. These have been chosen as their fields clearly interfere since they have the correct mode symmetry. For example LP₀₁ and LP₁₁ have similar polarization fields, but interfere strongly at the output, if the propagation length is altered. With LP₀₁ and LP₀₂, we have a similar result. We consider the case of a multimode fiber with these three modes propagating over a length of one meter and assume that the effective index of the modes LP₀₁ and LP₁₁ differ by 0.001 and that of LP₀₁ and LP₀₂ differ by 0.005. With these assumptions, we can calculate the interference signal (1=no interference to zero=destructive interference).

The graph in FIG. 2 shows the result of this exercise. Curve 202 shows the length change, δS due to a maximum displacement of the string (horizontal axis). This curve is almost a perfect quadratic (see Eq. above). Curve 204 is the optical path length difference (OPD) for LP₀₁-LP₁₁, and curve 205 shows the OPD for LP₀₁-LP₀₂. We ignore other modes as the interference signals are not very significant.

For the magnitude of the interference, curve 206 is for LP₀₁-LP₁₁, whereas curve 208 is for LP₀₁-LP₀₂. The sum of the magnitudes of these two is shown as curve 210. Note that if the string is biased at approximately 7 mm displacement, the interference is linear with vibration amplitude, for small perturbations. With greater displacement, the visibility suffers, until an amplitude of 17 mm is reached, when the visibility increases again, and can be linear with displacement. It is only possible to have a large variation in visibility if only two modes are present. This graph ignores real overlap integrals of the fields of the modes.

Using FIG. 2, it may be shown that the output signal from the photodiode varies periodically with displacement (strain, temperature), however its exact functional dependence is a function of the number of modes interfering. We have shown that to operate at what is known as the “quadrature” point, shown as point “A” in FIG. 2 (curve 210), it may be achieved by altering the length of the fiber by stretching it. Thus if the operating point drifts through a temperature change, stretching (or relaxing) the fiber brings it back to the desired operating point. However, if the function is not a purely periodic function, but quasi periodic, by continuing to stretch the fiber, another reference operating point may be arrived at, for example, B. Thus, by tracking the signal at the output, an error signal is generated in comparison to a reference which is used to run a motor to stretch (or relax) a section of a multimode fiber to bring the system back to the operating point. This has been demonstrated in the lab, even with a 100 meter length of multimode fiber before the stretched multimode fiber. Merely stretching a 1 meter section of fiber allows the operating point to be altered remotely. Certainly more than one cycle of interference may be achieved, and in practice we have seen more than six cycles by merely stretching the fiber.

Thus this technique can be used to stabilize a sensor remotely, allowing the measurement of fast changes in the parameter to be measured, which slow changes may be removed from the system. Alternatively, fast changes may be removed, whilst tracking slower changes, by using a faster stretching mechanism, using standard techniques well known in the art of sensing. This arrangement allows the concatenation of several sensors in a distributed sensing system.

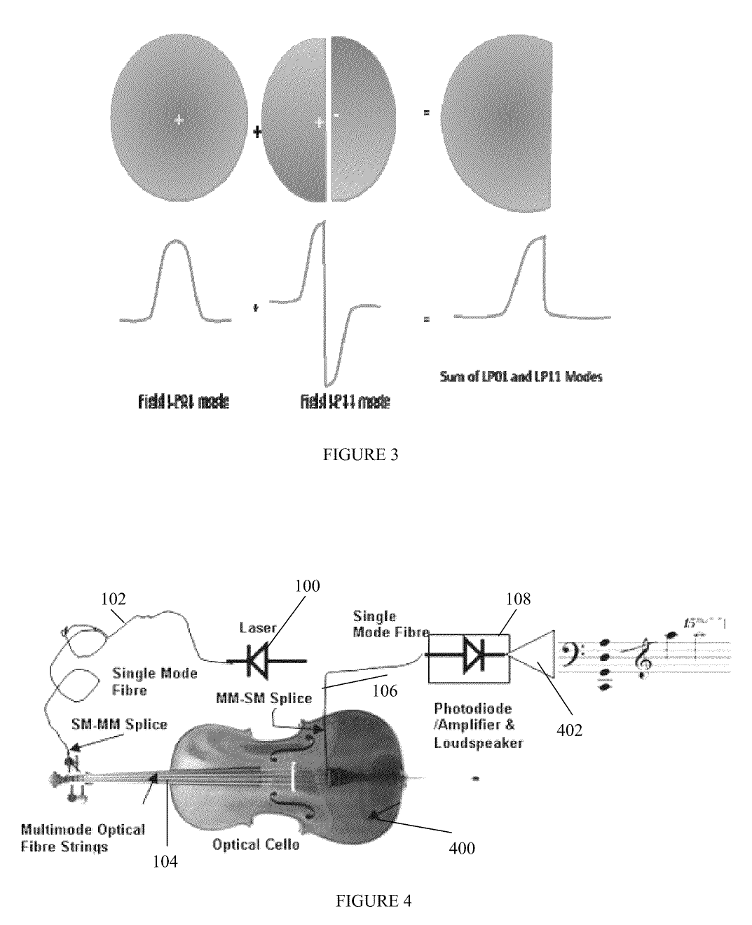

In the example shown in FIG. 3, the fields of two modes interact at some distance, z, and result in an intensity distribution. This is because the phase difference accumulates by each of the two modes after traveling that distance. The modes have propagation constants, β_{LP01} or β_{LP11} which are related to the effective refractive index, n_{eff} seen by the modes.

The pattern shown in FIG. 3 is extremely sensitive to any influence to the fiber, such as vibration, temperature, or strain, and rapidly changes as a result of these influences. When the multimode fiber 104 is perturbed, the propagation constants of the modes propagating in the fiber are also altered. The perturbation to the multimode fiber 104 is detected as a variation in the spatial interference pattern. The photo-detector 108 connected to the single mode fiber 106 thus detects a signal proportional to the intensity which is proportional to the vibration amplitude and the fast Fourier transform (FFT) shows the vibration frequency and its harmonics.

FIG. 4 illustrates one embodiment of the sensor of FIG. 1, whereby the sensor is a stringed musical instrument. In the example of FIG. 4, the instrument is a violin, but it may also be a guitar, viola, cello, double bass, or any instrument in which sound is produced by plucking, striking, or bowing taut strings. The instrument could also be a percussion instrument in which the fiber is intimately attached to the surface of the vibrating surface. The laser 100 is connected to the single mode fiber 102 which is coupled to the multi-mode fiber 104 using a Single Mode-Multimode (SM-MM) splice. The multimode fiber 104 is stretched over the violin 400, from the peg box on the neck of the instrument to the bridge on the body of the instrument. Tuning pegs are present in the peg box, around which the multi-mode fiber 104 is wrapped. A second single mode fiber 106 is coupled to the multimode fiber 104, and the output is then transmitted to the photo-detector 108. In this embodiment, the photo-detector 108 transforms the optical signal into an electrical signal that is then amplified and played on a speaker 402. The plucking or bowing of the optical fiber 104 results in a musical note being detected.

In one embodiment, a multimode fiber 104 is used for each string of the instrument 400. In another embodiment, a single multimode fiber 104 is used to replace all of the strings of the instrument 400. In this embodiment, the multimode fiber 104 is separated into multiple segments and each segment is capable of producing a different tone, due to it having a distinct resonance frequency. A single tensioned fiber can produce different notes from different section lengths. The tensioning of each segment will also affect the tone. In one embodiment, the segments are independently tensioned. In another embodiment, the segments are of varying lengths. In another embodiment, the masses of each fiber are different as the vibration frequency of the string is dependent inversely on the square root of the mass per unit length.

To get the correct sound, the instrument 400 is operated at a point at which the output is a linear function of the displacement of the fiber. This is done by stretching the fiber at an out of band frequency. Once the fibers are tensioned to the correct tension, a control mechanism, such as an additional multimode fiber called a “control fiber” is provided in series to control all of the other fibers and allow the sensor to operate at the quadrature point. The fibers may stretch with temperature or strain, but the control fiber will bring it back to the correct operating point. The frequency of operation for the control mechanism is either below the audible instrument frequency or well above it. Standard interferometer control techniques may also be used to keep the system at the quadrature point. For example, one way for controlling the interferometer is by tuning the laser.

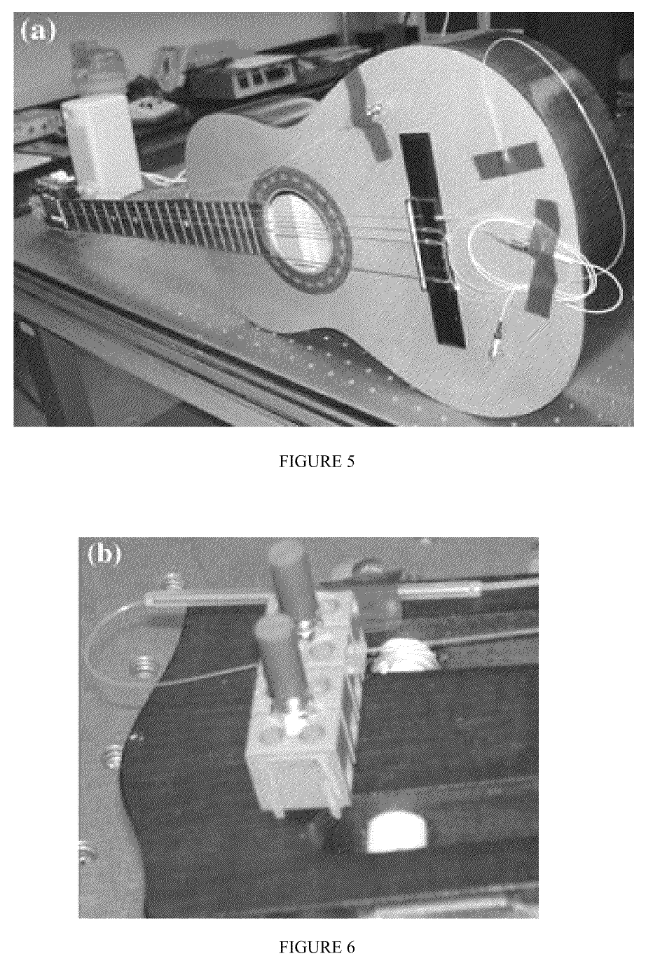

FIG. 5 illustrates an embodiment of the sensor as a guitar. The multimode optical fiber 104 is jacketed in the bridge of the guitar. Connectors are used on each end to connect the multimode fiber 104 to a single mode laser 102, 106. The multimode fiber 104 can be tensioned by clamping it close to the bridge and pulling it before clamping it at the peg box. Single mode laser 106 is pigtailed to a photodiode. FIG. 6 illustrates a replacement peg box provided on the neck of the instrument to hold the multimode fiber 104 and allow independent tensioning of each segment.

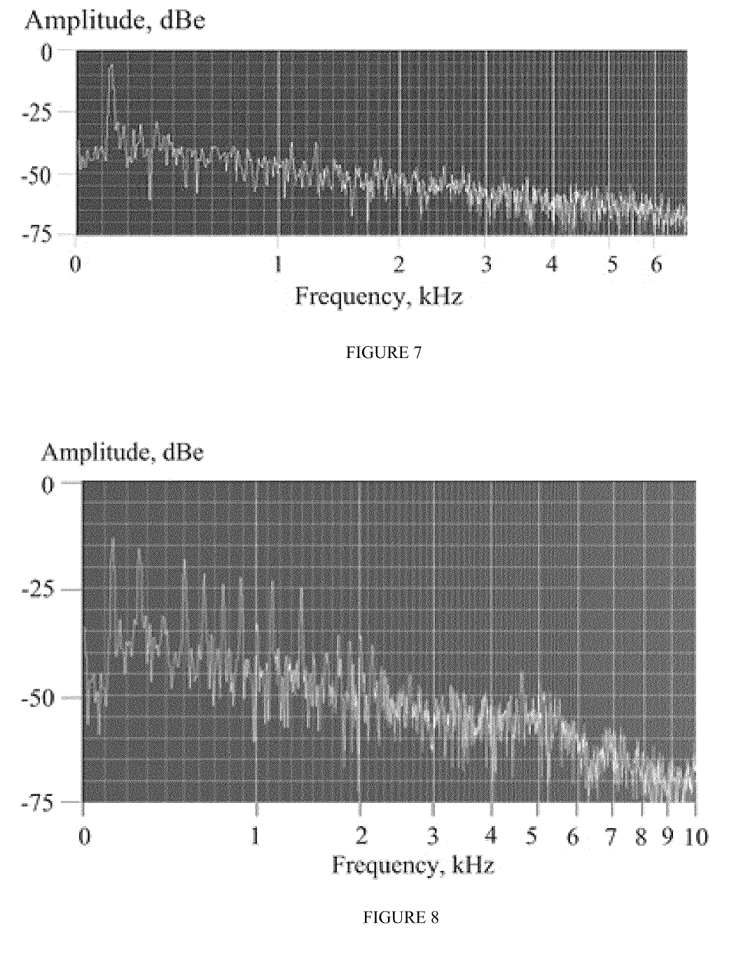

FIG. 7 shows the Fast Fourier Transform (FFT) spectra of a signal detected by striking the multimode optical fiber 106. In this figure, only one prominent frequency at around 125 Hz is visible, corresponding to the fundamental resonance of the stretched optical fiber 106. The physical sound emitted by the vibrating fiber is very faint, but can be compared with the recorded sound. These two sounds are noted to be identical. The recorded signal is an acoustic sound, with harmonic content. This is made clearer in FIG. 8, which shows the FFT spectra of the same fiber 104 after it was struck with more vigor. In FIG. 8, around 17 harmonics can be seen. In general, an acoustic sound is one, which is rich in harmonic content. The photo-detector faithfully detects the large number of harmonics, an observation almost impossible for a single or even multiple electrical pickups, for example, in an electric guitar.

It should be noted that despite the simple implementation, detailed information of the vibration can be extracted. With such an instrument, complex seismic data may be collected. When the fiber 104 is at rest, no signal can be detected. However, the state of the light output is dependent on a number of parameters, such as strain, temperature and stability of source wavelength.

With a simple feed-back loop, it is possible to stabilize the sensor in a frequency band outside the region of interest, for example by quadrature locking. This is done by noting that the signal of interest lies within a certain frequency band, and therefore any frequency outside of that band may be used to detect the state of the interferometer. For example, if the output detected by the photodiode changes due to a change in temperature which is usually slow, the interference signal changes slowly proportionally to the change in the temperature. However, due to the fact that the interference signal has a cyclical behavior [e.g. ∝ cos²(dt)] it is possible to control the output level at a fixed value by sampling the level at the output of the photodiode and then comparing it with a reference level. The difference is fed back to a motor or a stretching mechanism, which cancels the variation introduced by the drift inducing parameter.

The frequency of vibration f of an ideal string is given by the following relationship, noted Eq. 1:

$$f = \frac{k}{2 L} \sqrt{\frac{T}{μ}}$$

where, k is the mode of vibration, L is the length of the string, T is the tension applied and μ is the mass per unit length of the string.

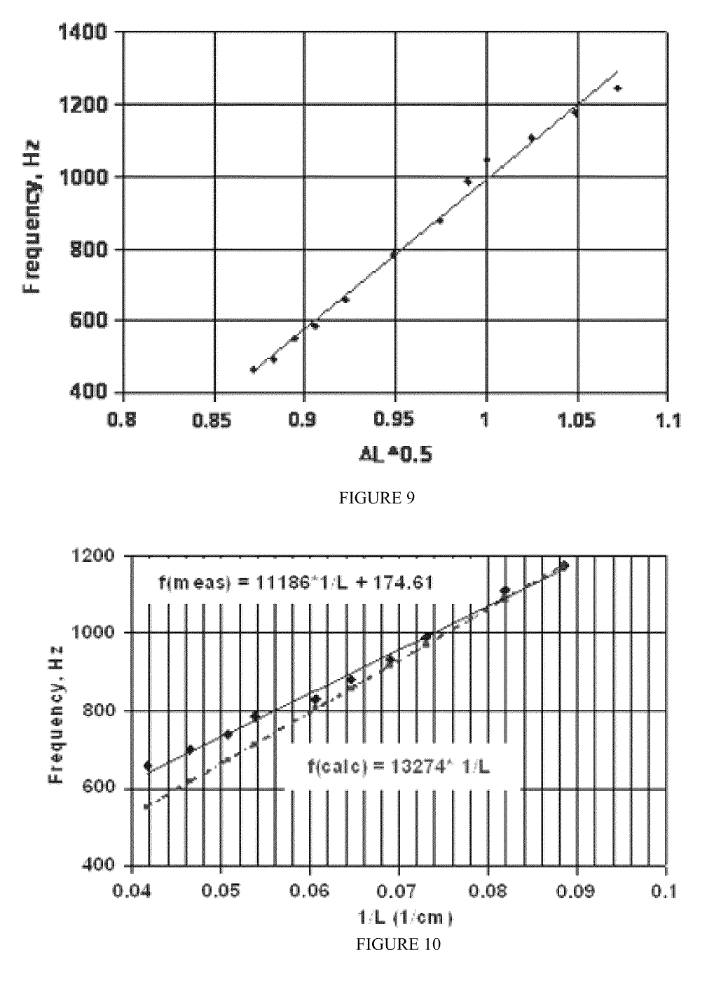

Experiments were carried out to ascertain this relationship for the multimode optical fiber. A multimode optical fiber was held by two metal rods, and each end was then wrapped around a cylinder, one of the cylinders being provided on a translational stage. The fiber tension was altered by moving the translation stage. As the tension is proportional to the elongation, to the first approximation, measurement of the change in length provided a measure of change in tension. The data are plotted in FIG. 9. The plots of frequency versus the square root of the extension show very good agreement with Eq. 1.

The second measurement was to alter the length of the optical fiber under constant tension. This indeed shows that the frequency detected is proportional to 1/L. The data is shown in FIG. 10. Both these measurements were performed with the use of a musical instrument frequency measurement device accurate to around 1%. Halving the length of the fiber changes the frequency by approximately an octave. We find that the frequency is proportional to 1/L but the slope does not allow the frequency to reach zero at infinite length, indicating that although the functional dependence is as per Eq. 1, the slope is different (a factor of 0.8) and the intercept is also not at zero. The difference in slope and the intercept at L=∞ may be due to multimode interference. It was noted that the three sections of the fiber (the main section supported by the steel rods, and the two adjacent sections between the rods and the cylinders), each produce a different tone, when struck by the metal rod, although it is the same piece of optical fiber. This means that several different sections of fiber may be used with the same laser and photodiode to assemble a series of vibration sensors, each with its own resonance frequency.

One question addressed during the experiment is how the bias level at the output plane at the junction of the single mode fiber can be altered. As the interference signal can only carry as a cosine squared function (i.e. between a normalized value of 0 and 1) any further perturbation produces harmonic distortion. As the ideal point of operation is the quadrature point i.e. mid way between 0 and 1, it is necessary to maintain the output level at this level. One way to solve this issue is to use a small loop of the multimode fiber to control the level on one end, either at the input or output. This loop, when twisted or touched, varies the output interference signal level through multimode interference and it has been demonstrated that by actively varying the position of the fiber, the output level can be altered and maintained at any desired level. Thus, by simple feedback from the average signal level at the output, an error signal can be derived to mechanically alter the position of the fiber loop, thereby altering the bias. This signal need only be at very low frequency (<10 Hz) as the signal varies only slowly.

The experiment has shown that the stretched multi-mode optical fiber is an excellent vibration, temperature, and strain sensor. In one embodiment, the optical fiber may be coated with a material, such as PZLT (poly-vinylidene-fluoride), to provide other applications in direct electric field sensing.

The embodiments of the invention described above are intended to be exemplary only. The scope of the invention is therefore intended to be limited solely by the scope of the appended claims.

I/We claim:

1. An optical fiber sensor for sensing one of vibration, temperature, and strain, comprising:
a laser source;
a first single mode optical fiber having a first end and a second end, the first end connected to the laser source for receiving and propagating light from the laser source;
a multimode optical fiber having a first end and a second end, the first end connected to the second end of the first single mode optical fiber for receiving said light and thereby exciting a plurality of modes of said multimode optical fiber, the multimode optical fiber being stretched at an out of band frequency and operated at a point at which an output is a linear function of a displacement of the multimode fiber; and
a sampling photo-detector module connected to the second end of the multimode optical fiber for spatially filtering an output of said multimode fiber to obtain a spatially filtered interference pattern, and for detecting a variation of said spatially filtered interference pattern when one of said vibration, temperature, and strain is applied to said multimode optical fiber.

2. The sensor of claim 1, wherein the sampling photo-detector module comprises a second single mode optical fiber for said spatially filtering and a photodiode for said detecting.

3. The sensor of claim 1, wherein the sampling photo-detector module comprises a small area photodiode for sampling and detecting.

4. The sensor of claim 1, further comprising a control mechanism to return the sensor to an operating point once the multimode optical fiber is stretched.

5. The sensor of claim 4, wherein the control mechanism is a multimode control fiber in series with the multimode optical fiber.

6. The sensor of claim 1, wherein the multimode optical fiber comprises a plurality of segments, each one of said segments having a distinct resonance frequency.

7. The sensor of claim 1, wherein the sensor is a musical instrument, and said multimode optical fiber represents a string of said musical instrument.

8. The sensor of claim 6, wherein said sensor is a guitar, and the multimode optical fiber represents all strings of said guitar and is jacketed multiple times in a peg box with a tuning peg for each one of said segments.

9. The sensor of claim 6, wherein each one of the segments is independently tensioned.

10. The sensor of claim 9, wherein the segments are of varying lengths.

11. The sensor of claim 1, wherein the multimode optical fiber is coated with a material.

12. The sensor of claim 1, further comprising an amplifier for amplifying an output signal.

13. A method for sensing one of vibration, temperature, and strain, the method comprising:
stretching a multimode optical fiber at an out of band frequency such that it operate at a point at which an output is a linear function of a displacement of the multimode optical fiber;
powering a laser source coupled to a first end of a first single mode optical fiber;
propagating light through said first single mode optical fiber, a second end of said first single mode optical fiber being coupled to a first end of the multimode optical fiber;
exciting a plurality of modes in said multimode optical fiber by coupling said light propagating through said first single mode optical fiber into said multimode optical fiber;
spatially filtering an output of said multimode fiber to obtain an interference pattern; and
detecting a variation of said interference pattern when one of said vibration, temperature, and strain is applied to said multimode optical fiber.

14. The method of claim 13, wherein said spatially filtering comprises receiving an output of said multimode optical fiber into a second single mode optical fiber and transmitting an output of said second single mode optical fiber to a photo-detector.

15. The method of claim 13, further comprising returning the sensor to an operating point once the multimode optical fiber is stretched using a control mechanism.

16. The method of claim 13, wherein said detecting comprises detecting a variation of said interference pattern from one of a plurality of segments of said multimode optical fiber, each one of said segments having a distinct resonance frequency.

17. The method of claim 13, further comprising producing a musical tone from said variation of said interference pattern.

18. The method of claim 17, wherein said producing a musical tone comprises producing a different musical tone from different segments of said multimode optical fiber, each one of said segments having a distinct resonance frequency.

19. The method of claim 13, further comprising amplifying an output signal.

20. A musical instrument comprising:
a housing having a neck and a body;
a plurality of tuning pegs at one end of said neck;
a bridge on the body; and
a multimode fiber having a plurality of segments stretched at an out of band frequency and operated at a point at which an output is a linear function of a displacement of the multimode fiber, each one of said segments extending from one of said tuning pegs to the bridge, the bridge holding the multimode fiber in place on the body, the multimode optical fiber being wrapped around each one of the tuning pegs, the tuning pegs adjustable for tensioning each of the segments of the multimode optical fiber.
